(19) United States
(12) Patent Application Publication
(10) Pub. No.: US 2011/0147553 A1
(43) Pub. Date: Jun. 23, 2011

(54) Fastening device for add-on components on mounting rails

(75) Inventors: Peter Ostermeier, Diessen (DE); Norbert Burtscher, Thueringen (AT); Hermann Fritz, Landsberg (DE)

(73) Assignee: Hilti Aktiengesellschaft, Schaan (LI)

(21) Appl. No.: 12/928,646

(22) Filed: Dec. 16, 2010

(30) Foreign Application Priority Data
Dec. 17, 2009 (DE) DE 102009054861.0

(51) Int. Cl. F16M 13/02; F16M 13/00; F16B 47/00

(52) U.S. Cl. 248/223.41; 24/682.1; 24/304

(57) ABSTRACT

A device (1) for fastening an add-on component (3, 4) to a support part (5), including at least one catching part (8) that can be inserted into an opening (10) of the support part (5) and that can catch behind at least one edge (9) of the support part (5) with at least one movable holding element (16) which, when it is inserted into the opening (10), can be moved into a catching position owing to contact between the at least one catching part (8) and the support part (5), so that it can be inserted into the opening (10), and which can be moved into a catching position by a return movement of the at least one holding element (16) after it has been inserted into the opening (10), so that the at least one holding element (16) can catch behind the at least one edge (9) of the support part (5) so as to create a positive connection between the at least one holding element (16) and the support part (5), at least one affixer (12) for affixing the add-on component (3, 4) to the device (1), should make it possible to fasten add-on components (3, 4) to the support part (5) by the device (1) employing a simple technical set-up and without having to use tools. In the catching position, the at least one holding element (16) is arranged completely in a chamber (17) surrounded by the support part (5).

This claims the benefit of German Patent Application DE 10 2009 054 861.0, filed Dec. 17, 2009 and hereby incorporated by reference herein.

The present invention relates to a device for fastening an add-on component to a support part, and to a system for fastening an add-on component to a support part.

In structural engineering, devices for fastening an add-on component to a support part are employed in order to fasten add-on components to a support part. Examples of add-on components are photovoltaic modules, façade elements or lines as components of a water-heating system or of an electric installation. In general, support rails or mounting rails are employed as the support parts.

### BACKGROUND

German Patent Application No. DE 103 13 564 A1 shows a connection element for components. The components are provided with slots that are aligned with each other for purposes of receiving the connection element, whereby the connection element is configured as a one-piece spring clip that has diametrically projecting spring arms whose width is dimensioned so they can be inserted into the slots, whereby a bearing section is at an axial distance opposite from the free ends of the spring arms, said bearing section being shaped onto the spring clip and having an engagement section for a mounting tool.

German Patent Application No. DE 10 2006 011 836 B3 discloses a fastening element having a baseplate. Opposing first arms, which each have a first contact section, project from the baseplate at a first distance from the baseplate, and at least two opposing second arms, which have a second contact section, also project from the baseplate at a second distance from the baseplate. Here, the first arms have actuation sections that are each configured as a surface with an eyelet.

German Patent Application No. DE 10 2007 042 484 B3 discloses a device for fastening an add-on component to a support part, having a head part that has contact sections projecting laterally and that is intended for contact with the add-on component or with the support part. An elastic front wall arrangement has two barrier flaps that are oriented approximately at a right angle relative to the front wall. These barrier flaps have latching steps that rest on the support part when the device is in a catching position.

### SUMMARY OF THE INVENTION

It is an object of the present invention to provide a device and a system with which add-on components can be fastened to a support part using the device and using the system employing a simple technical set-up and without having to use tools. Furthermore, the device and the system should be cost-effective to produce and should allow simple and reliable handling.

The present invention provides a device for fastening an add-on component to a support part, comprising at least one catching part that can be inserted into an opening of the support part and that can catch behind at least one edge of the support part with at least one movable holding element which, when it is inserted into the opening, can be moved into an engagement position owing to contact between the at least one catching part and the support part, so that it can be inserted into the opening, and which can be moved into a catching position by means of a return movement of the at least one holding element after it has been inserted into the opening, so that the at least one holding element can catch behind the at least one edge of the support part so as to create a positive connection between the at least one holding element and the support part, also comprising at least one means for affixing the add-on component to the device, whereby, in the catching position, the at least one holding element is arranged completely in a chamber surrounded by the support part. Therefore, the device advantageously has a compact and simple structure since the at least one holding element, as a movable component of the device, does not take up much installation space, and a reliable connection between the device and the support part is easily ensured.

In one particular embodiment, the at least one catching part comprises at least two holding elements, and/or the at least one holding element is in the catching position, especially exclusively on a wide side surface and/or on a narrow side surface of the at least one holding element, and/or two holding elements are arranged opposite from each other.

In another embodiment, the device can be fastened to the support part by a snap-in and/or latching mechanism.

Advantageously, the at least one holding element can be an integral part of the at least one catching part.

In a supplementary embodiment, the at least one movable holding element is not pre-tensioned in the pre-mounting position. The at least one movable holding element is in the pre-mounting position when the device is not mounted on the support part and the at least one holding element is not in the insertion position and/or in the catching position.

Preferably, the at least one movable holding element is configured to be essentially, especially exclusively, plate-shaped or disk-shaped. In this manner, the at least one holding element can be produced easily and cost-effectively, allowing a reliable connection between the device and the support part to be made.

In another embodiment, the at least one means encompasses a carrier plate for purposes of affixing the device to the add-on component, preferably directly.

In another embodiment, the at least one means encompasses an adhesive, latching, riveted and/or screwed connection for purposes of affixing the add-on component to the device, especially to the carrier plate.

In a supplementary embodiment, the device encompasses at least one engagement part that can be inserted into the opening of the support part.

Preferably, the geometry of the at least one engagement part is adapted to the geometry of the opening of the support part in such a way that the at least one engagement part can be at least partially inserted into the opening.

In one variant, the at least one engagement part has a preferably wedge-shaped projection that can be inserted into the opening.

In one supplementary variant, the at least one engagement part, aside from the projection, is configured with an essentially disk-like or plate-like shape.

In a practical manner, the at least one engagement part may be arranged between the at least one catching part and the carrier plate. The at least one catching part thus may be arranged on or fastened to the carrier plate indirectly by means of the at least one engagement part.

In another embodiment, the carrier plate and/or the at least one engagement part and/or the at least one catching part is configured in one piece or in multiple pieces.

In particular, the at least one holding element can be pivoted around a rotational axis and/or a translatory movement can be executed by the at least one holding element, thanks to a bearing, and/or the at least one holding element can be moved back and forth, since the at least one holding element itself can be elastically deformed and/or the at least one holding element can be elastically deformed by means of at least one separate elastic element, especially a spring.

In a supplementary embodiment, the device is made at least partially, especially completely, of plastic or metal, for instance, aluminum or steel.

The invention also relates to a system according to the invention for fastening an add-on component to a support part, comprising a device for fastening the add-on component to the support part, comprising at least one catching part that can be inserted into an opening of the support part and that can catch behind at least one edge of the support part with at least one movable holding element which, when it is inserted into the opening, can be moved into an engagement position owing to contact between the at least one catching part and the support part so that it can be inserted into the opening, and which can be moved into a catching position by means of a return movement of the at least one holding element after it has been inserted into the opening, so that the at least one holding element can catch behind the at least one edge of the support part so as to create a positive connection between the at least one holding element and the support part, also comprising at least one means for affixing the add-on component to the device, and also comprising the support part, whereby the device is configured as a device described in this patent application.

In another embodiment, the support part is a support rail, and/or the opening is preferably a groove and/or the opening opens up into a chamber delimited by the inside contour of the support part, so that the at least one edge is formed by the inner contour of the support part so that it can catch behind the at least one holding element.

In a supplementary embodiment, the opening is a mounting opening for fastening the device to the support part.

In a supplementary variant, when the device is fastened to the support part, two opposing holding elements are oriented with respect to a plane that runs through a central longitudinal axis of the support rail in such a way that the plane runs through the two holding elements and the plane is divided by the central longitudinal axis of the rail into a first partial plane and a second partial plane, and a first holding element is intersected by the first partial plane while a second holding element is intersected by the second partial plane. The central longitudinal axis of the rail is oriented in the direction of the greatest extension of the support rail and it runs through the center point or through the center of gravity of the support rail.

In another variant, the at least two holding elements can be pivoted around a rotational axis essentially parallel—that is to say, with a deviation of less than 10°, especially less than 5°—to the longitudinal axis of the rail, or else the rotational axis is oriented at an angle, preferably an essentially right angle, relative to the longitudinal axis of the rail, and/or, before the holding elements are inserted into the opening, the distance between the ends of two opposite holding elements in the direction of the distance is greater than the clear width of the opening in the direction of the distance, so that, when the two opposite holding elements are inserted, the holding elements can be moved due to the contact with the support part, especially in such a way that the maximum distance is reduced.

In another embodiment, when the device is fastened to the support part, the at least one holding element is pre-tensioned on the support part in the catching position, and/or the fastening of the device to the support part is a permanent connection.

### BRIEF DESCRIPTION OF THE DRAWINGS

Embodiments of the invention will be described in greater detail below with reference to the accompanying drawings. The following is shown:

FIG. 1: a cross section of a system for fastening an add-on component, in an exploded view;

FIG. 2: a perspective view of an engagement part with a catching part;

FIG. 3: a perspective view of the catching part, in a first embodiment;

FIG. 4: a perspective view of catching parts as a modular arrangement, in a second embodiment;

FIG. 5: a perspective view of several catching parts, in a third embodiment;

FIG. 6: a cross section of the system for fastening the add-on component, in a pre-mounting state;

FIG. 7: a cross section of the system according to FIG. 6, during insertion of the device into an opening of the support part;

FIG. 8: a cross section of the system according to FIG. 6, in a final mounted state;

FIG. 9: a cross section of a device, in a first embodiment;

FIG. 10: a perspective view of the device, in a second embodiment;

FIG. 11: a perspective view of the catching part, in a second embodiment;

FIG. 12: a detailed view of the system, with the catching part according to FIG. 11, in the final mounted state.

### DETAILED DESCRIPTION

In the fields of structural engineering and construction, devices 1 are employed for fastening an add-on component 3 to a support part 5. The add-on component 3 is, for instance, a photovoltaic module 4, a façade element or a line, and the support part 5 is a support rail 6 or a mounting rail 7. Therefore, the device 1 can be used to fasten the add-on component 3 to the support part 5 indirectly.

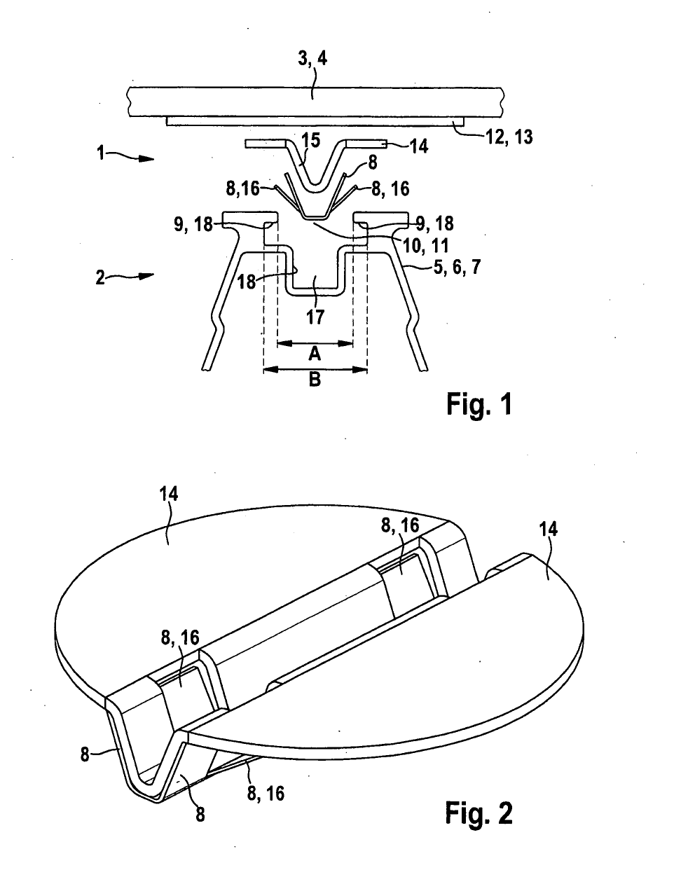

The device 1 comprises a carrier plate 13 as a means 12 for affixing the add-on component 3 to the device 1, an engagement part 14 with a projection 15 and a catching part 8 with a movable holding element 16 (FIGS. 1, 2, 6, 7 and 8). The carrier plate 13, the engagement part 14 and the catching part 8 are made of metal, for example, steel or aluminum, and they are especially joined together, for instance, by means of adhesion or welding, or else by a positive connection, for example, with screw or rivets for purposes of creating a screwed or riveted connection. The add-on component 3 is fastened to the carrier plate 13 analogously. The engagement part 14, aside from the projection 15, is configured so as to be essentially disk-shaped or plate-shaped (FIG. 2). As a result, the engagement part 14 can be easily joined to the disk-shaped or plate-shaped carrier plate 13.

The mounting rail 7 has an opening 10 as a mounting opening, which is configured as a groove 11. The groove 11 extends with its larger extension in the direction of the longitudinal axis 19 of the rail. In this context, the inner contour 18 of the mounting rail 7 surrounds a chamber 17 into which the opening 10 opens up. In an orientation perpendicular to the plane of projection of FIG. 1, 6, 7 or 8, the clear width A of the opening 10 is smaller than the clear width B of the chamber 17 adjacent to the opening 10. Together with the device 1, the mounting rail 7, which is likewise made of metal, for instance, aluminum or steel, or else of plastic, forms a system 2 for fastening the add-on component 3 to the support part 5.

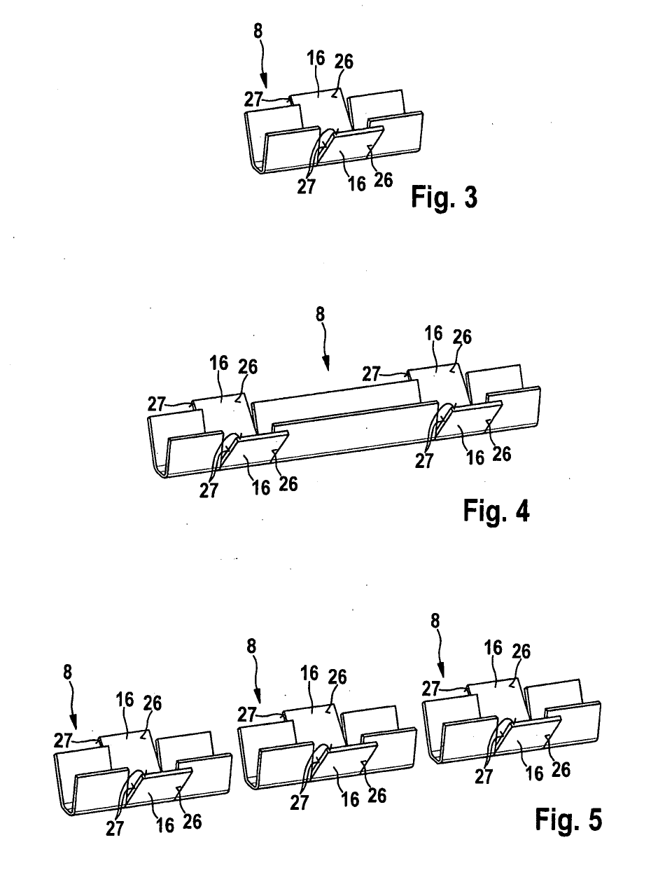

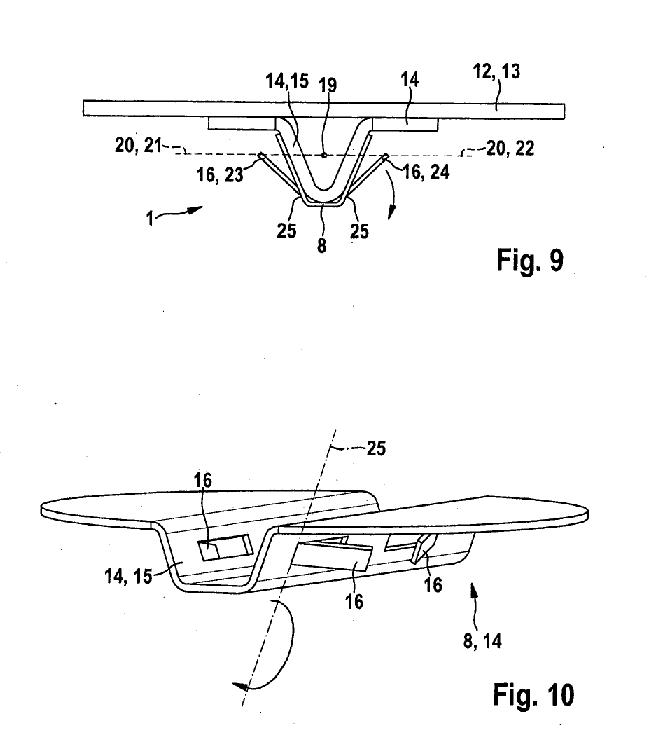

The catching part 8 has a holding element 16 that can be pivoted around a pivoting axis 25 (FIGS. 1 to 10). Here, the catching part 8 can be configured as a single piece having two holding elements (16) (FIG. 3), as a single piece having more than two holding elements 16 (FIG. 3), for example, four holding elements 16 (FIG. 4), or else in modular form having several pieces, for instance, three catching parts 8 (FIG. 5). In this context, the rotational axis 25 of the holding element 16 either can be oriented parallel to the longitudinal axis 19 of the rail in accordance with the embodiment in FIG. 9, or else the rotational axis 25 can be oriented at an angle, e.g. a right angle. FIG. 10 shows the engagement part 14 and the catching part 8 configured as a single part. In the embodiment of the device 1 shown in FIG. 9, two holding elements 16 are oriented opposite from the central longitudinal axis 19 of the rail. A plane 20 that passes through the longitudinal axis 19 of the rail and that intersects the two holding elements 16 is divided by the longitudinal axis 19 of the rail into a first partial plane 21 and a second partial plane 22. The first partial plane 21 intersects the first holding element 23, while the second partial plane 22 intersects the second holding element 24. The essentially disk-shape or plate-shaped holding elements 16 have two wide side surfaces 26 and three narrow side surfaces 27 (FIG. 3).

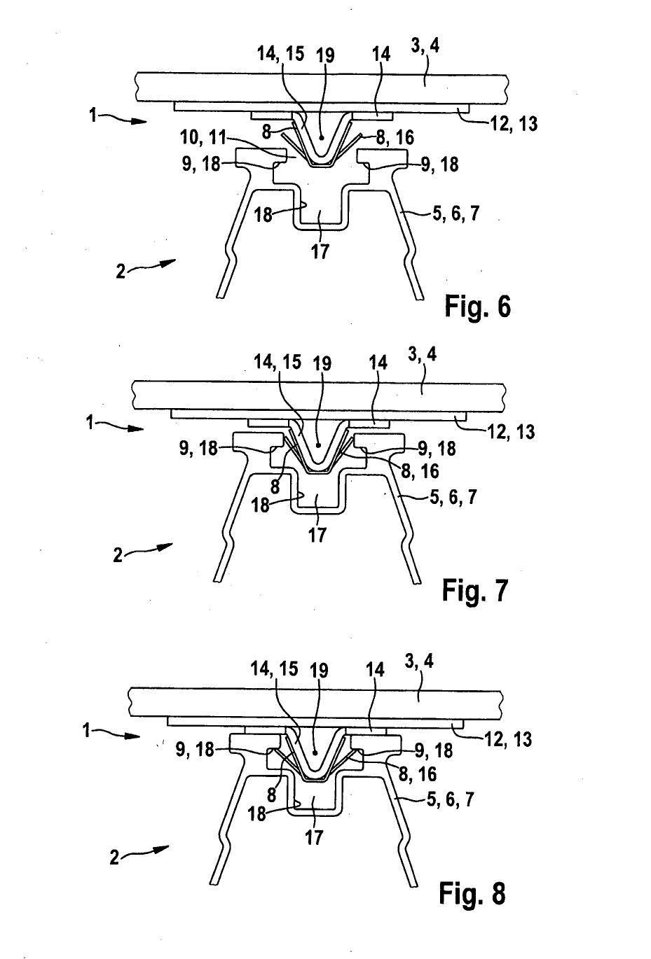

FIGS. 6 to 8 show the mounting sequence, that is to say, the fastening of the device 1 to the mounting rail 7. FIG. 6 depicts a pre-mounting state in which the holding elements 16 are in a pre-mounting position and the add-on part 3 is firmly joined to the device 1. In the pre-mounting position, the holding elements 16 are not pre-tensioned. The holding elements 16 are movable owing to the elastic deformation of the holding elements 16 or of the catching part 8. The holding elements 16 are thus also spring elements. In the pre-mounting state depicted in FIG. 6, the distance between the ends of the holding elements 16 in a direction parallel to a plane formed by the carrier plate 13 and parallel to the plane of projection of FIG. 6 (distance direction) is greater than the clear width A of the opening 10 or mounting opening 10. When the device 1 is inserted and moved into the opening 10 and into the chamber 17, the wedge-shaped orientation of the two holding elements 16 causes them to pivot around the rotational axis 25, so that the right-hand holding element 16 shown in FIG. 7 pivots in a counterclockwise rotational direction around the rotational axis 25, while the left-hand holding element 16 moves in a clockwise rotational direction around the rotational axis 25. As a result, the two holding elements 16 are moved from the pre-mounting position into the engagement position shown in FIG. 7. In the engagement position as depicted in FIG. 7, the above-mentioned distance between the ends of the holding elements 16 is smaller than in the pre-mounting position of the holding elements 16. When the projection 15 of the device 1 is inserted into the chamber 17, the contact between the ends of the holding elements 16 or between the outermost narrow side surfaces 27 and the mounting rail 7 is ended, so that the holding elements 16 move or snap into the catching position according to FIG. 8 due to the elastic deformability of the holding elements 16. Consequently, the holding elements 16 recover from the engagement position depicted in FIG. 7 and go into the catching position depicted in FIG. 8.

In the catching position of the holding elements 16 according to FIG. 8, the holding elements 16 rest with the front edges of the upper wide side surfaces 26 on the support rail 6, especially on the inner contour 18 of the support part 5 or of the mounting rail 7. As a result, a positive connection is created between the device 1 and the support part 5.

When the device 1 is mounted on the support part 5, the device 1 can be first placed onto the support rail 6. The distance between the holding elements 16 at the ends is greater than the clear width A of the opening 10. In order to move the device 1 from the pre-mounting state according to FIG. 6 into a position according to FIG. 7 when the device 1 is being inserted into the opening 10 of the support part 5, owing to the requisite elastic deformation of the holding elements 16, additional force has to be exerted downwards onto the device 1 in order to overcome the elastic forces of the holding elements 16. The weight of the device 1 and of the add-on component 3 is not sufficient for this purpose. The elastic properties of the holding elements 16 or of the catching part 8 have been designed appropriately for this purpose. As a result, before the projection 15 is pressed into the opening 10 in order to reach the catching position, the device 1 and the add-on component 3 can be moved on the mounting rail 7 in a direction perpendicular to the plane of projection of FIGS. 6 to 8. In this manner, for example, when photovoltaic modules 4 are to be mounted, they can be first oriented on the mounting rail 7, in other words, perpendicular to the plane of projection of FIGS. 6 to 8, and then, only once the final mounting position of the photovoltaic modules 4 has been reached, they can be finally fastened to the mounting rail 7 by additionally pressing and applying a downward force, as depicted in FIGS. 6, 7 and 8 in that the device 1 is moved into the final mounted state as shown in FIG. 8.

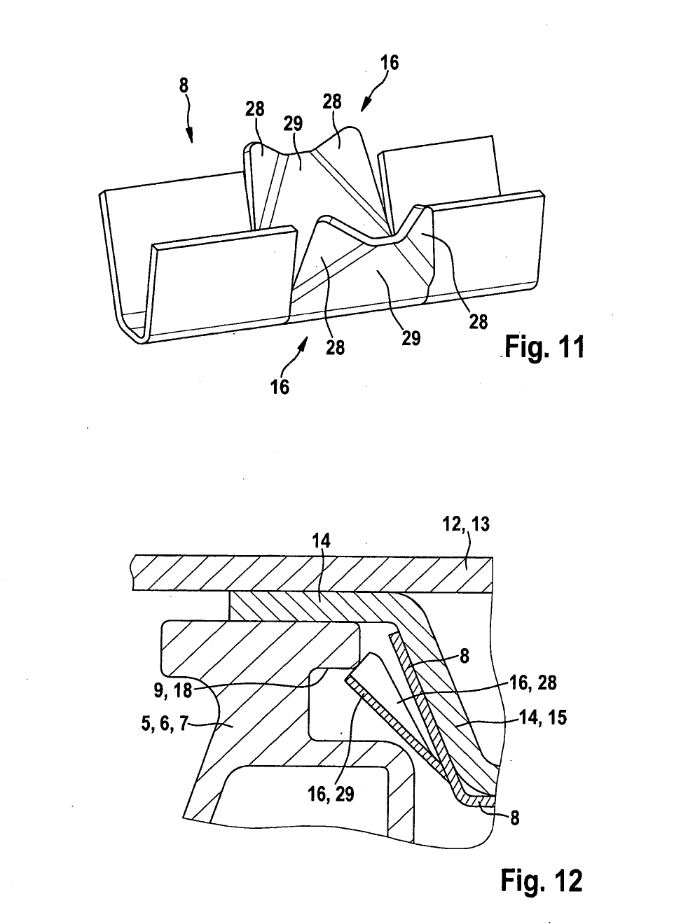

FIGS. 11 and 12 depict a second embodiment of the catching part 8. The holding elements 16 each have at least one wedge element for wedging with the support rail 6. Preferably, the holding elements 16 each have two essentially triangular bevels 28 on the sides and a center part 29 in between. The two bevels 28 and the center part 29 are single pieces and form a holding element 16 having a geometry that differs from that of the holding element 16 of the catching part 8 in the above-mentioned first embodiment. In the final mounted position of the holding elements 16 (FIG. 12), the upper narrow side surface 26—which is formed by the two bevels 28 and by the center part 29—of the holding elements 16 rests on the support rail 6. The two holding elements 16 are thus clamped with a wedge effect on the inner contour 18 of the support rail. Therefore, the holding elements 16 are pre-tensioned in the catching position owing to their elastic deformability. Consequently, the device 1 is additionally fastened to the support part 5 non-positively as well. Due to the wedge-like arrangement of the holding elements 16 in the chamber 17, additional pre-tensioning between the device 1 and the support part 5 occurs when the support rail 6 is moved downwards, for instance, due to settling, so that such movements cause the device 1, and thus also the add-on component 3, to be moved along.

On the whole, the device 1 according to the invention and the system 2 according to the invention entail considerable advantages. Add-on components 3 are fastened to support parts 5 in a structurally simple manner. This translates into cost savings during the production of the device 1 and of the system 2 and, owing to the absence of pre-tensioning of the holding elements 16 in the pre-mounting state, no unintentional movement of the holding elements 16 occurs. Therefore, in the pre-mounting state, neither the device 1 nor the system 2 sustain any damage when the device 1 is subjected to small forces while in the pre-mounting state. Even settling or movements of the support part 5 can be partially or completely absorbed by the system 2 in that the device 1 moves along with the movement of the support part 5.

What is claimed is:

1. A device for fastening an add-on component to a support part, comprising:
at least one catching part insertable into an opening of the support part and capable of catching behind at least one edge of the support part with at least one movable holding element, the holding element, when inserted into the opening, moveable into an engagement position owing to contact between the at least one catching part and the support part, so that the catching part can be inserted into the opening and be moveable into a catching position by a return movement of the holding element after the catching part has been inserted into the opening, so that the at least one holding element can catch behind the at least one edge of the support part so as to create a positive connection between the at least one holding element and the support part;
at least one means for affixing the add-on component to the device,
the holding element, in the catching position, being arranged completely in a chamber surrounded by the support part.

2. The device as recited in claim 1 wherein the at least one catching element includes a further holding element, and/or the holding element rests against the support part when in the catching position exclusively on a wide side surface and/or on a narrow side surface of the holding element, and/or a further holding element is arranged opposite the holding element.

3. The device as recited in claim 1 wherein the holding element is plate-shaped or disk-shaped.

4. The device as recited in claim 1 wherein the at least one means includes a carrier plate for affixing the device to the add-on component.

5. The device as recited in claim 1 further comprising at least one engagement part insertable into the opening of the support part.

6. The device as recited in claim 5 wherein a geometry of the at least one engagement part is adapted to a further geometry of the opening of the support part in such a way that the at least one engagement part can be at least partially inserted into the opening.

7. The device as recited in claim 5 wherein the at least one engagement part has a wedge-shaped projection insertable into the opening.

8. The device as recited in claim 5 wherein the means includes a carrier plate and the at least one engagement part is arranged between the at least one catching part and the carrier plate.

9. The device as recited in claim 1 wherein the at least one catching part is configured in multiple pieces.

10. The device as recited in claim 1 wherein the one holding element is pivotable around a rotational axis and/or a translatory movement can be executed by the holding element via a bearing, and/or the holding element is moveable back and forth, since the holding element is elastically deformable and/or the at least one holding element is elastically deformable via at least one separate elastic element.

11. A system for fastening an add-on component to a support part, comprising:
the device as recited in claim 1; and
the support part.

12. The system as recited in claim 11 wherein the support part is a support rail, and/or the opening is a groove, and/or the opening opens up into a chamber delimited by the inside contour of the support part, so that the at least one edge is formed by an inner contour of the support part so that the holding element can catch.

13. The system as recited in claim 12 wherein when the device is fastened to the support part, the holding element and a further opposing holding element are oriented with respect to a plane running through a central longitudinal axis of the support rail in such a way that the plane runs through the holding element and the further holding element and the plane is divided by the central longitudinal axis of the rail into a first partial plane and a second partial plane, and the holding element is intersected by the first partial plane while the further holding element is intersected by the second partial plane.

14. The system as recited in claim 12 further comprising an opposite further holding element, the holding element and the further holding element pivtable around a rotational axis parallel to the longitudinal axis of the rail, or else the rotational axis is oriented at an angle, preferably a right angle, relative to the longitudinal axis of the rail, and/or, before the holding element and the further holding element are inserted into the opening, a distance between the ends of the holding element and the opposite further holding element in a direction of the distance is greater than the clear width of the opening in the direction of the distance, so that, when the holding element and the opposite further holding elements are inserted, the holding elements can be moved due to the contact with the support part.

15. The system as recited in claim 11 wherein when the device is fastened to the support part the holding element is pre-tensioned on the support part in the catching position, and/or the fastening of the device to the support part is a permanent connection.

16. A device for fastening an add-on component to a support part, comprising:
at least one catching part insertable into an opening of the support part and capable of catching behind at least one edge of the support part with at least one movable holding element, the holding element, when inserted into the opening, moveable into an engagement position owing to contact between the at least one catching part and the support part, so that the catching part can be inserted into the opening and be moveable into a catching position by a return movement of the holding element after the catching part has been inserted into the opening, so that the at least one holding element can catch behind the at least one edge of the support part so as to create a positive connection between the at least one holding element and the support part;
an affixer affixing the add-on component to the at least one catching part,
the holding element, in the catching position, being arranged completely in a chamber surrounded by the support part.

17. The device as recited in claim 16 wherein the affixer includes adhesive, a weld or a positive connection connecting the add-on component to the at least one catching part.

18. The device as recited in claim 16 wherein the affixer includes a carrier plate fixed to the add-on component and to the at least one catching part.

19. The device as recited in claim 18 further comprising at least one engagement part located between the carrier plate and the at least one catching part.
